(19) United States
(12) Patent Application Publication
(10) Pub. No.: US 2010/0070366 A1
(43) Pub. Date: Mar. 18, 2010

(54) SYSTEM AND METHOD FOR PROVIDING NAMING SERVICE IN A DISTRIBUTED PROCESSING SYSTEM

(76) Inventors: Makoto KOIKE, Yokohama (JP); Toru SHIMOTORI, Yokohama (JP)

Correspondence Address: MCDERMOTT WILL & EMERY LLP, 600 13TH STREET, N.W., WASHINGTON, DC, 20005-3096, US

(21) Appl. No.: 12/623,587

(22) Filed: Nov. 23, 2009

Related U.S. Application Data
(63) Continuation of application No. 10/696,563, filed on Oct. 30, 2003, now abandoned.

(30) Foreign Application Priority Data
Mar. 28, 2003 (JP) 2003-091723

(51) Int. Cl. G06Q 30/00

(52) U.S. Cl. 705/14.49

(57) ABSTRACT

The invention provides a technique in which a plurality of different transaction services provided by a plurality of nodes constituting a distributed processing system can be searched efficiently, particularly provides name information to achieve various kinds of services in the distributed processing system efficiently. A first node accepts a name information retrieval request from a second node. The first node sends the name information retrieval request to a third node designated by a system definition. The first node acquires name information from the third node and stores the name information in a global cache. The first node retrieves name information based on the retrieval request from a local cache of the first node and the global cache and sends the name information to the second node.

### BACKGROUND OF THE INVENTION

The present invention relates to an effective technique adapted to a naming service providing system for providing name information to efficiently utilize program resources in a distributed processing system.

In a conventional distributed processing system, a list of remote procedure call (RPC) service information including address information and load balancing information of each service is provided as name information to achieve RPC efficiently.

A client for performing RPC executes a program to send an inquiry to each naming service for providing name information, acquire information concerning requested service and decide an appropriate destination (IP address and port number) of RPC. On that occasion, upon reception of the inquiry from the client, the naming service acquires information of service operated on a first node and information of service operated on a node designated by a system definition and provides name information to the client. Information acquired by the naming service from the node designated by the system definition is only information of service operated on the node. When the naming service must acquire name information of other nodes, for example, in the case where a node is added newly, it is therefore necessary to change the contents of the system definition to make it possible to send the retrieval request to the other nodes.

A conventional client server system and a conventional naming service method in which server objects in a client server system including a plurality of server machines having various kinds of server programs (server objects) to make it possible to provide one information service selectively from two or more server machines are dynamically assigned to respective client terminals to distribute server load, have been proposed, for example, in JP-A-2001-92766.

### SUMMARY OF THE INVENTION

In the conventional naming service, information of service operated on the first node (which may be a computer or an information processor or which may be a program or an object for performing such processing) in the distributed processing system and information of service operated on the node designated by the system definition are acquired at the time of retrieval of service. Accordingly, when information of service operated on nodes not designated by the system definition, such as other nodes which are constituent members of the distributed processing system, needs to be acquired, it is necessary to add those nodes to the system definition so that the retrieval request can be sent to the added nodes. Furthermore, when nodes which are constituent members of the distributed processing system are changed, it is necessary to change the system definition of each node in accordance with the changed contents of each node. The load required for managing the system definition is heavy.

An object of the invention is to provide a technique for solving the aforementioned problem so that a plurality of different transaction services (functions such as transaction processes provided by execution of programs or objects) provided by a plurality of nodes as constituent members of a distributed processing system can be retrieved efficiently.

Another object of the invention is to provide a technique in which name information of services can be sent efficiently when states of a plurality of different transaction services provided by a plurality of nodes constituting a distributed processing system are changed.

The invention provides a naming service providing system for providing name information to achieve various kinds of transaction services in a distributed processing system efficiently, in which name information of a first node and name information of other nodes designated by a system definition are retrieved successively and sent to a retrieval requester when a name information retrieval request is received.

In the naming service providing system according to the invention, when a client using various kinds of transaction services by client-server communication represented by RPC is to use a certain transaction service, the client first sends a request to naming service of a retrieval source server to acquire name information indicating the IP address, the port number, etc. of an application server (a server for providing a plurality of transaction services) providing the transaction service.

Upon reception of the name information acquisition request, the retrieval source server accepts the name information acquisition request from the client, reads the system definition of the retrieval source server and sends a name information retrieval request to a name server designated by the system definition.

The name server accepts the name information retrieval request from the retrieval source server as a second node, reads a system definition stored in a storage device of the name server and sends the name information retrieval request to a second name server as a third node designated by the system definition.

In each node after the second name server, the same processing as described above is repeated. In a node that does not send the name information retrieval request to any other name server because the node is located in the lowest class in the name server group, name information stored in a local cache included in the node is sent, as a reply to the name information retrieval request, back to a higher-class node as a sender of the retrieval request.

Upon reception of the reply from the lower-class node, the name server stores the name information acquired from the lower-class node in a global cache, reads the name information from the local cache of its own node and the global cache and sends the read name information, as a reply to the name information retrieval request, back to the higher-class node as a sender of the retrieval request. Such processing is performed successively.

When the name server accepting the name information retrieval request from the retrieval source server receives the reply from the second name server, the name server stores the name information acquired from the second name server in the global cache, reads the name information from the local cache of its own node and the global cache and sends the read name information back to the retrieval source server as the second node in the same manner as described above.

Upon reception of the reply from the name server, the retrieval source server stores the name information acquired from the name server in the global cache, retrieves name information requested by the client from the local cache of its own node and the global cache and sends the retrieved name information back to the client in the same manner as described above.

As described above, in the invention, the name information retrieval request is sent to lower-class nodes successively. Accordingly, service information can be acquired when name information is retrieved from the local cache of the first node, the local cache of each of other nodes designated by the system definition and the global cache. A transaction service can be retrieved from a plurality of transaction services in a distributed processing system.

As described above, in the naming service providing system according to the invention, when a name information retrieval request is received, name information of the first node and name information of other nodes designated by the system definition are retrieved successively and sent to the retrieval requester. Accordingly, a transaction service can be efficiently retrieved from a plurality of different transaction services provided by a plurality of nodes constituting a distributed processing system.

### BRIEF DESCRIPTION OF THE DRAWINGS

FIG. 1 is a diagram showing the schematic configuration of a naming service providing system according to an embodiment of the invention;

FIG. 2 is a diagram showing the schematic configuration of a name server for providing naming service in this embodiment;

FIG. 3 is a view showing an example of configuration of name information in this embodiment;

FIG. 4 is a flow chart showing a procedure of a name information retrieval process in this embodiment;

FIG. 5 is a diagram showing an example of processing in a hierarchized distributed processing system in this embodiment;

FIG. 6 is a diagram showing an example of a name information deleting/updating process at the time of occurrence of failure in this embodiment;

FIG. 7 is a flow chart showing a procedure of an advertising process in this embodiment; and

FIG. 8 is a diagram showing an example of the advertising process in this embodiment.

### DESCRIPTION OF THE EMBODIMENTS

A naming service providing system for providing name information to achieve various kinds of service in a distributed processing system efficiently will be described below as an embodiment of the invention.

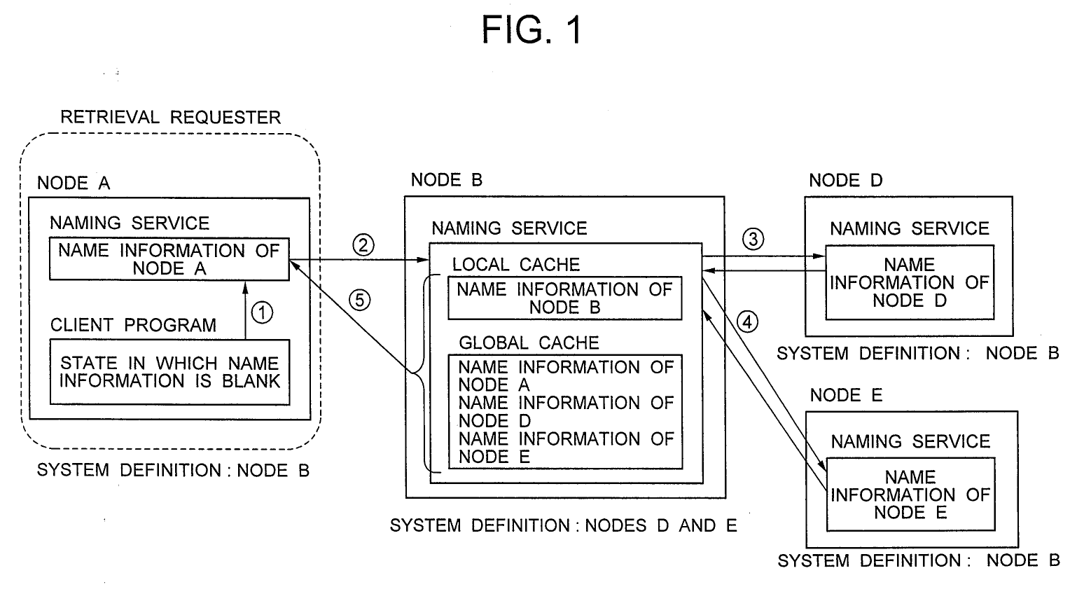

FIG. 1 is a diagram showing the schematic configuration of the naming service providing system according to this embodiment. In the naming service providing system according to this embodiment, naming service processing for providing name information is carried out by execution of a program.

As shown in FIG. 1, in the naming service providing system according to this embodiment, when a client (e.g., a program or an object) at node A as a retrieval requester (which may be a computer or an information processor or which may be a program or an object for carrying out such processing) issues a retrieval request, the retrieval request is first given to naming service of node A as shown in (1). Then, the naming service of node A gives the retrieval request to naming service of node B in accordance with the system definition of the retrieval requester as shown in (2).

Upon reception of the retrieval request from node A, the naming service of node B examines name information of nodes D and E designated by the system definition of node B as shown in (3) and (4) and updates name information in both local cache and global cache included in node B. Then, the naming service of node B sends the name information back to the naming service of node A as the retrieval requester as shown in (5).

As described above, in this embodiment, when node B receives a request to retrieve name information, node B sends name information of node B and name information of other nodes D and E designated by the system definition of node B to node A as the retrieval requester. Accordingly, when node A as the retrieval requester once gives a retrieval request to node B, services of a plurality of nodes B, D and E can be retrieved.

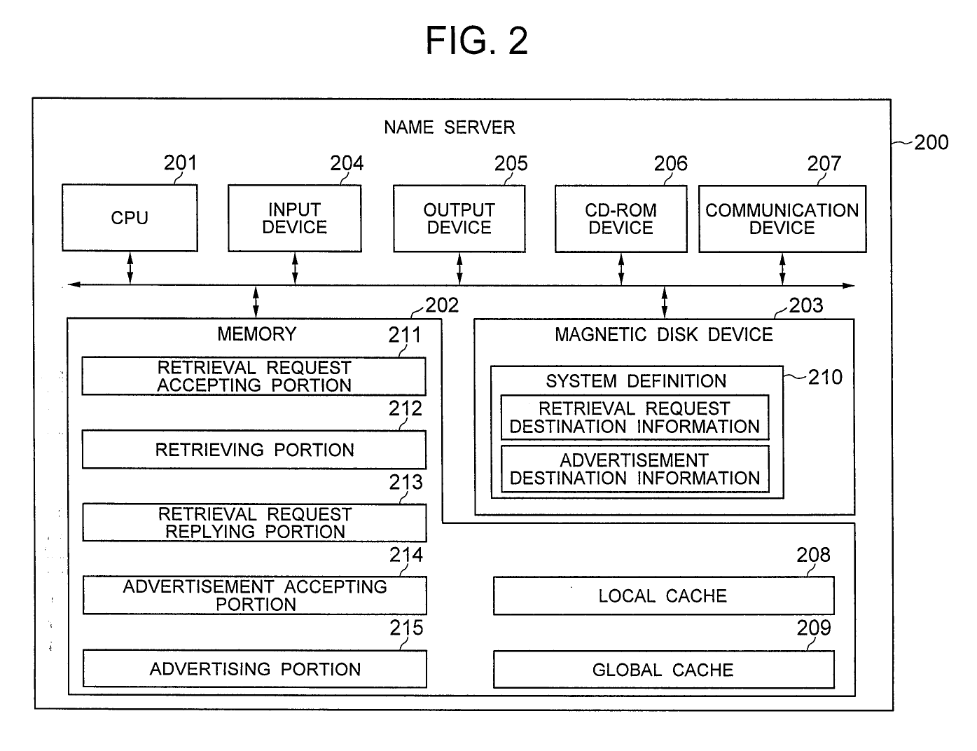

FIG. 2 is a diagram showing the schematic configuration of a name server (which may be a computer or an information processor or which may be a program) for providing naming service in this embodiment. As shown in FIG. 2, the name server 200 in this embodiment includes a CPU 201, a memory 202, a magnetic disk device 203, an input device 204, an output device 205, a CD-ROM device 206, a communication device 207, a local cache 208, a global cache 209, and a system definition 210.

The CPU 201 is a device for controlling the operation of the name server 200 as a whole. The memory 202 is a storage device which is loaded with various kinds of processing programs and data for controlling the operation of the name server 200 when the CPU 201 controls the operation of the name server 200 as a whole.

The magnetic disk device 203 is a storage device in which the various kinds of processing programs and data are stored. The input device 204 is a device for performing various kinds of inputs to provide name information to other nodes. The output device 205 is a device for performing various kinds of outputs accompanying the provision of name information.

The CD-ROM device 206 is a device for reading the contents of a CD-ROM in which the various kinds of processing programs are recorded. The communication device 207 is a device for communicating with other nodes through a network such as the Internet or an intranet.

The local cache 208 is a storage device for storing name information of service operated at its own node. The global cache 209 is a storage device for storing name information acquired from other nodes. The system definition 210 is a file for storing information of nodes as destinations of the name information retrieval request or destinations of advertisement.

The name server 200 further includes a retrieval request accepting portion 211, a retrieving portion 212, a retrieval request replying portion 213, an advertisement accepting portion 214, and an advertising portion 215.

The retrieval request accepting portion 211 is a processing portion for accepting a name information retrieval request from any one of other nodes. The retrieving portion 212 is a processing portion for sending the name information retrieval request to nodes as retrieval request destinations designated by the system definition 210, acquiring name information from the nodes and storing the name information in the global cache 209.

The retrieval request replying portion 213 is a processing portion for reading name information as a result of the retrieval request from the local cache 208 and the global cache 209 of its own node and sending the name information to a node which is the retrieval requester. The advertisement accepting portion 214 is a processing portion for receiving name information of state-changed service due to start, stop, etc. from other nodes and reflecting the received name information in the global cache 209 of its own node.

The advertising portion 215 is a processing portion for sending name information of state-changed service of its own node and name information received by advertisement from other nodes to nodes which are destinations of advertisement designated by the system definition 210.

A program for making the name server 200 function as each of the retrieval request accepting portion 211, the retrieving portion 212, the retrieval request replying portion 213, the advertisement accepting portion 214 and the advertising portion 215 is recorded in a recording medium such as a CD-ROM, stored in a magnetic disk or the like and then loaded to the memory so that the program can be executed. Incidentally, the CD-ROM as a recording medium for recording the program may be replaced by another recording medium. The program may be used after installed from the recording medium into an information processor or may be used after access to the recording medium is gained through a network.

Each node shown in FIG. 1 has the same configuration as that of the name server 200 shown in FIG. 2. That is, each node shown in FIG. 1 processes retrieval requests and advertisement received from other nodes. The contents of the system definition in each node shown in FIG. 1, however, vary according to the hierarchical structure, etc. of the distributed processing system.

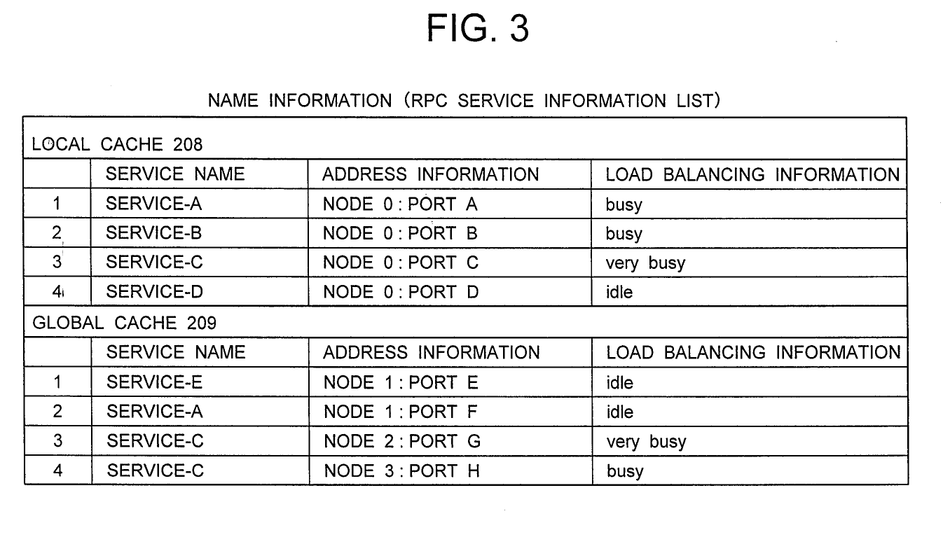

FIG. 3 is a view showing an example of configuration of name information in this embodiment. As shown in FIG. 3, name information in this embodiment is provided as a list of RPC service information managed by naming service existing on each node in order to achieve RPC in the distributed processing system efficiently. Service names for identifying provided services, address information of nodes on which programs for providing the services are operated, and load balancing information for indicating load states of the nodes are stored in this list. The load state of each node is evaluated on the basis of the rate of CPU utilization, the I/O state to a disk, the number of members in a queue for service and the throughput rate per unit time. For example, the load state of each node is evaluated to be classified into several levels, such as “idle” indicating a blank state, “busy” indicating a processible state and “very busy” indicating a processing jam-up state.

In the naming service providing system according to this embodiment, processing in the case where the name server 200 receives a name information retrieval request from any one of other nodes will be described below.

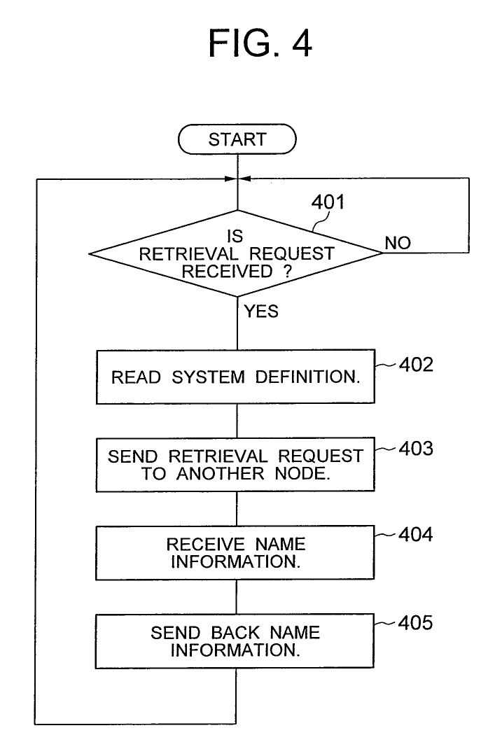

FIG. 4 is a flow chart showing a procedure of a name information retrieval process in this embodiment. In step 401 shown in FIG. 4, the retrieval request accepting portion 211 of the name server 200 judges whether a request to retrieve name information is received from any one of other nodes through a network or not. When the name information retrieval request is received, the retrieval request accepting portion 211 accepts the name information retrieval request and the current position of the procedure goes to step 402.

In the step 402, the retrieving portion 212 refers to the system definition 210, reads information indicating nodes as destinations of the retrieval request from the system definition 210 and decides transmission destinations of the retrieval request. Transmission destinations may be decided after nodes which have already sent the retrieval request are excluded so that the retrieval request does not become redundant. For example, as information indicating nodes to be excluded from transmission destinations at the retrieval request after that, exclusive information including information of its own node and information of nodes designated by the system definition may be sent together with the retrieval request to the next node. In this case, nodes designated by the system definition of the next node but not included in the exclusive information can be regarded as next transmission destinations to prevent the retrieval request from becoming redundant.

For example, in the node configuration as shown in FIG. 1, if node A is written in the system definition of each of nodes B, D and E in the case where a client program (having no name information) of node A sends a retrieval request, the retrieval request redundant like a loop is sent because the retrieval request is sent from each of nodes B, D and E to node A. However, if node A as the first node and node B designated by the system definition of node A are set in exclusive information for indicating nodes to be excluded from transmission destinations at the retrieval request after that when the retrieval request is sent from node A, the retrieval request can be prevented from becoming redundant because the retrieval request is prevented from being sent from nodes B, D and E to nodes A and B.

In step 403, the retrieving portion 212 generates a name information retrieval request by copying the received retrieval request and sends the generated retrieval request to the nodes decided as transmission destinations.

In step 404, name information is received from the nodes to which the retrieval request has been sent. Then, the global cache 209 is searched to judge whether name information identical to the received name information has been already stored in the global cache 209. When the name information has not been stored yet, the name information is stored in the global cache 209.

In step 405, the retrieval request replying portion 213 reads name information stored in the local cache 208 of its own node and the global cache 209 and sends the read name information to a sender of the retrieval request received in the step 401.

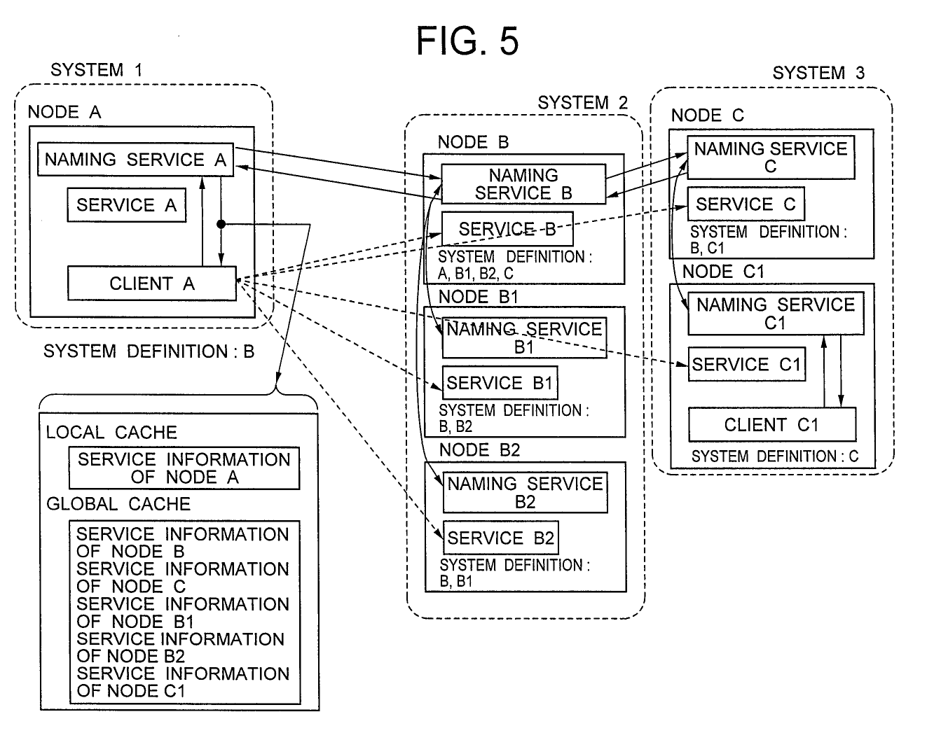

FIG. 5 is a diagram showing an example of processing in a hierarchized distributed processing system in this embodiment. The distributed processing system shown in FIG. 5 is hierarchized into three classes, namely systems 1 to 3. The system 1 is constituted by only one node A. The system 2 is constituted by three nodes B, B1 and B2. The system 3 is constituted by two nodes C and C1.

In general, when client A issues a name information retrieval request at node A, it is apt to acquire no information but information of service A as name information of node A and information of service B concerning node B designated by the system definition of node A. In such case, it is therefore necessary to change and manage the system definition of node A to acquire name information of other nodes. That is, when the system definition of node A is changed, it is necessary to manage the system definition because the system definition of node A must be changed whenever the configuration of the system 2 or 3 is changed.

In the naming service providing system according to this embodiment, when a retrieval request is sent from node A to node B, the retrieval request is further sent to nodes B1, B2 and C designated by the system definition of node B. Consequently, name information of all nodes in the systems 1 to 3 can be acquired.

That is, when the retrieval request accepting portion 211 of node A accepts a name information retrieval request from the client A as shown in FIG. 5, the retrieving portion 212 of node A reads information of nodes A and B designated as destination nodes of the retrieval request by the system definition 210, excludes node A as its own node from the read information and sends the retrieval request to node B belonging to a class different from the class to which its own node A belongs.

When the retrieval request accepting portion 211 of node B accepts the name information retrieval request from node A, the retrieving portion 212 of node B reads information of nodes B, B1, B2 and C designated as destination nodes of the retrieval request by the system definition 210 and sends the name information retrieval request to nodes B1 and B2 belonging to a class to which its own node B belongs, and node C belonging to a class different from the class to which its own node B belongs.

Similarly, when the retrieval request accepting portion 211 of node C accepts the name information retrieval request from node B, the retrieving portion 212 of node C sends the name information retrieval request to node C1 belonging to a class to which its own node C belongs.

In this embodiment, exclusive information for indicating nodes to be excluded from destinations of the retrieval request may be sent together with the retrieval request so that the retrieval request does not become redundant. For example, when a retrieval request is sent from node A to node B, exclusive information for indicating node A to be excluded may be added to the retrieval request. Similarly, when a retrieval request is sent from node B to node C, exclusive information for indicating nodes A, B, B1 and B2 to be excluded may be added to the retrieval request.

When node C1 receives the name information retrieval request from node C, the retrieval request replying portion 213 of node C1 reads name information of service C1 from the local cache 208 of its own node C1 and sends the name information of service C1 back to node C.

When node C receives the name information from node C1, the retrieving portion 212 of node C stores the received name information in the global cache 209, and the retrieval request replying portion 213 reads name information of services C and C1 from the local cache 208 of its own node C and the global cache 209 and sends the name information back to node B.

When node B receives name information from nodes B1, B2 and C to which the retrieval request has been sent, the retrieving portion 212 of node B stores the name information in the global cache 209 and sends name information of nodes B1, B2, C and C1 stored in the global cache 209 and name information of service B stored in the local cache 208 back to node A.

When node A receives name information of nodes B, B1, B2, C and C1 from node B, the retrieving portion 212 of node A stores the name information in the global cache 209. Then, the retrieval request replying portion 213 of node A retrieves name information of service requested by the client A from the local cache 208 and the global cache 209 and sends the retrieved name information back to the client A.

As described above, in this embodiment, when the distributed processing system is hierarchized into a plurality of classes, a process of sending a name information retrieval request to other nodes belonging to a class to which its own node belongs, and a specific node belonging to a class different from the class to which its own node belongs, is carried out in each class. Accordingly, even in the case where the requester of the retrieval request does not entirely grasp the hierarchical structure, information of all services in the distributed processing system can be searched.

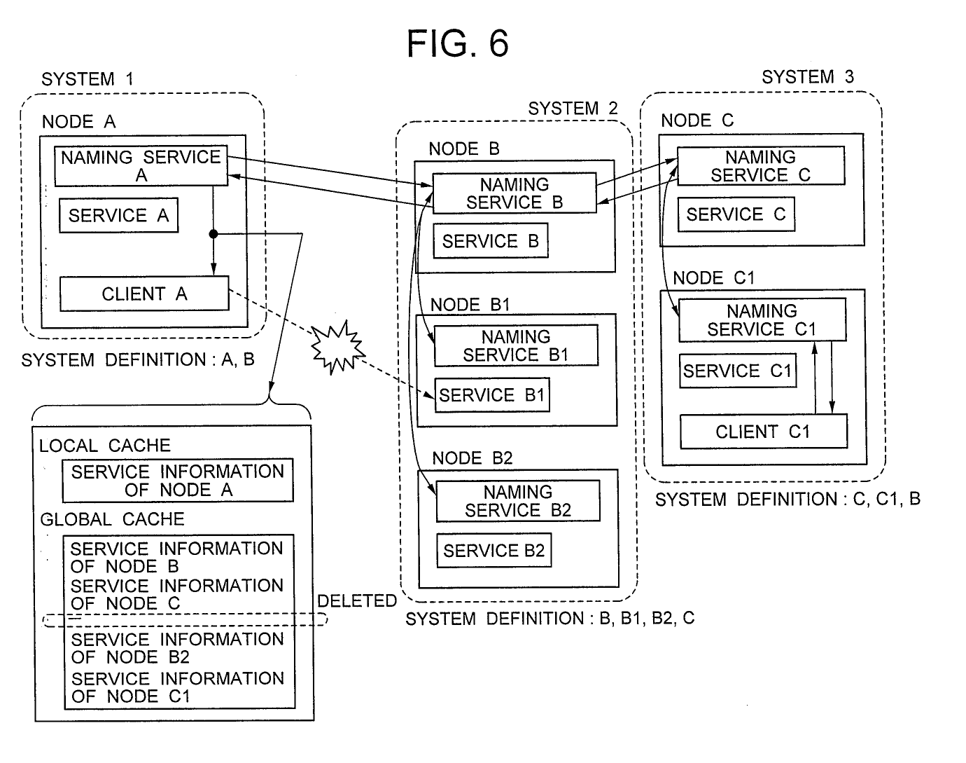

FIG. 6 is a diagram showing an example of a name information deleting/updating process at the time of occurrence of failure in this embodiment. FIG. 6 shows a process of examining name information of nodes designated by the system definition 210 and updating name information on the local cache 208 or the global cache 209 when interruption of service is detected and a request to delete the name information is sent in the case where the name information retrieved in the aforementioned manner is used for carrying out RPC.

That is, when error such as no response from node B1 occurs in the case where the client A acquiring name information of service B1 accesses node B1 by RPC in the aforementioned manner, the client A detects interruption of service B1 and sends a request to node A to delete the name information of service B1.

When node A receives the name information deletion request, the retrieval request accepting portion 211 of node A accepts the name information deletion request from the client A, deletes information of service B1 from the global cache 209 and instructs the retrieving portion 212 to examine name information. The retrieving portion 212 of node A examines name information of nodes designated by the system definition 210, that is, updates name information on the local cache 208 or the global cache 209 in the same manner as in the case of the retrieval request to thereby distribute name information having deleted name information of service B1 to each node.

Incidentally, the cause of no response from node B1 may be conceivably communication error in network other than failure in node B1. Therefore, when interruption of service B1 is detected, node A may send data such as Keep Alive to the node having detected interruption of service to thereby inquire whether the node is operative or not. That is, node A may delete name information of the service in accordance with whether the node having detected interruption of service replies or not.

In the naming service providing system according to this embodiment, a process in the case where the name server 200 advertises name information for other nodes will be described below.

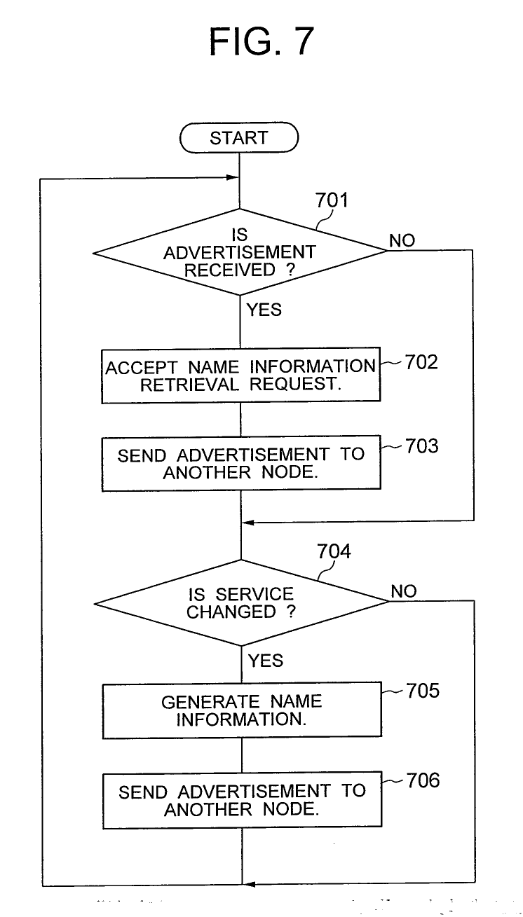

FIG. 7 is a flow chart showing a procedure of an advertising process in this embodiment. As shown in FIG. 7, in step 701, the advertisement accepting portion 214 of the name server 200 judges whether name information of state-changed service is received as advertisement from another node or not. When advertised name information is received, the current position of the process goes to step 702.

In the step 702, the global cache 209 of its own node is searched so that it is judged whether name information corresponding to the received name information has been already stored in the global cache 209 of its own node or not. When the name information has been already stored, the name information is updated. When the name information has not been stored yet, the name information is added to the global cache 209 of its own node. Then, the current position of the process goes to step 703.

In the step 703, the advertising portion 215 reads information indicating nodes as destinations of advertisement designated by the system definition 210 and decides transmission destinations of the received name information. The destinations of advertisement may be decided after nodes in which advertisement has been already executed are excluded so that the advertisement does not become redundant. For example, as information for indicating nodes to be excluded from destinations of advertisement after that, exclusive information including information of its own node and information of nodes designated by the system definition may be sent together with the advertisement to a next node. In this case, nodes designated by the system definition of the next node but not included in the exclusive information can be regarded as next destinations of the advertisement, so that the advertisement can be prevented from becoming redundant.

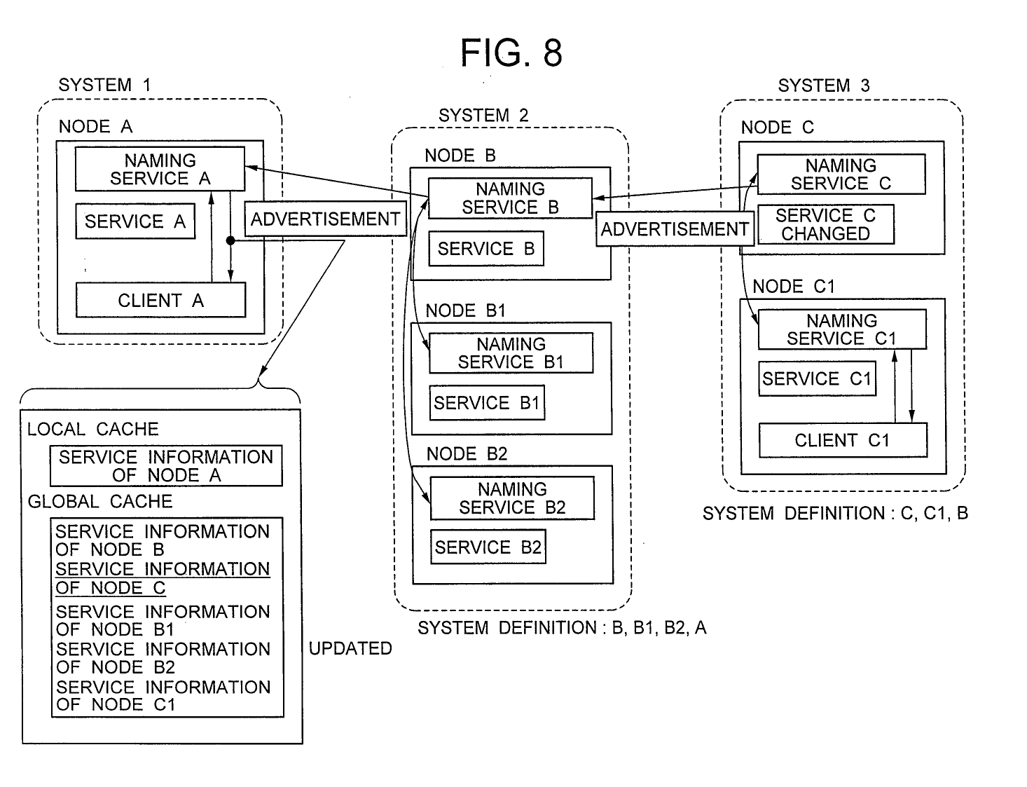

For example, in the node configuration as shown in FIG. 8, if node C is written in the system definition of the system 1 or 2 when advertisement is sent from node C, advertisement redundant like a loop is executed because advertisement is sent from nodes A and B to node C. If information indicating node C as its own node and nodes C1 and B defined in the system definition of node C is set as exclusive information for indicating nodes to be excluded from destinations of advertisement after that when advertisement is sent from node C, redundant advertisement can be prevented because advertisement can be prevented from being sent from nodes A and B to node C.

Then, the advertising portion 215 judges whether the state of service in its own node is changed or not. The change of the state of service is change in start or interruption of service in its own node, change in load state, or the like. When the state of service is changed, the current position of the process goes to step 705.

In the step 705, new name information for indicating the changed state of service is generated. Then, the local cache 208 of its own node is searched so that it is judged whether name information corresponding to the received name information has been already stored in the local cache 208 of its own node or not. When the name information has been already stored, the name information is updated to the newly generated name information. When the name information has not been stored yet, the name information is added to the local cache 208 of its own node.

In step 706, information indicating nodes as destinations of advertisement designated by the system definition 210 is read and transmission destinations of the received name information are decided in the same manner as in the step 703.

When the retrieval request accepting portion 211 accepts a name information retrieval request from the client or the like, the retrieval request replying portion 213 reads name information based on the retrieval request from the local cache 208 and the global cache 209 updated by the advertisement and sends the name information to the requester.

FIG. 8 is a diagram showing an example of the advertising process in this embodiment. The distributed processing system shown in FIG. 8 is hierarchized into three classes, namely, systems 1 to 3 in the same manner as in FIG. 5.

In general, when node C detects and advertises the change of the state of service C, information of service C is apt to be sent to only nodes C1 and B designated by the system definition of node C. It is therefore necessary to change and manage the system definition of node C so that node A can acquire the name information. That is, when the system definition of node C is changed, it is necessary to manage the system definition because the system definition of node C must be changed whenever the configuration of the system 1 is changed.

In the naming service providing system according to this embodiment, when advertisement is sent from node C to node B, the advertisement is sent to nodes B1, B2 and A designated by the system definition of node B so that all nodes in the systems 1 to 3 can acquire the new name information.

That is, when the advertising portion 215 of node C detects the change of the state of service C as shown in FIG. 8, the advertising portion 215 of node C generates name information indicating the state, reads information of nodes C, C1 and B designated as destination nodes of advertisement by the system definition 210, excludes node C as its own node from the read information and sends the advertisement of name information to node C1 belonging to a class to which its own node C belongs, and to node B belonging to a class different from the class to which its own node C belongs.

When the advertisement accepting portion 214 of node B accepts the advertisement of name information from node C, the advertisement accepting portion 214 of node B reflects the contents of the received name information in the global cache 209 of its own node B. Then, the advertising portion 215 of node B reads information of nodes B, B1, B2 and A designated as destination nodes of advertisement by the system definition 210 and sends the advertisement of name information to nodes B1 and B2 belonging to a class to which its own node B belongs, and to node A belonging to a class different from the class to which its own node B belongs.

When the advertisement accepting portion 214 in each of nodes A, B1 and B2 accepts the advertisement of name information from node C, the advertisement accepting portion 214 in each of nodes A, B1 and B2 reflects the contents of the received name information in the global cache 209 of its own node. When a name information retrieval request is accepted from the client or the like, the retrieval request replying portion 213 reads name information based on the retrieval request from the global cache 209 updated by the advertisement and sends the name information to the requester.

As described above, in this embodiment, when the distributed processing system is hierarchized into a plurality of classes, a process of sending advertisement of name information to other nodes belonging to a class to which its own node belongs, and to a specific node belonging to a class different from the class to which its own node belongs, is carried out in each class. Accordingly, even in the case where a sender of advertisement does not entirely grasp the hierarchical structure, all necessary name information in the distributed processing system can be updated.

As described above, in the naming service providing system according to this embodiment, when a name information retrieval request is received, name information of its own node and name information of other nodes designated by the system definition are retrieved successively and sent to the requester. Accordingly, a plurality of different transaction services provided by a plurality of nodes constituting a distributed processing system can be searched efficiently.

Furthermore, in the naming service providing system according to this embodiment, when name information of state-changed service is received, the name information is successively sent to other nodes designated by the system definition. Accordingly, when the state of a transaction service in a plurality of different transaction services provided by a plurality of nodes constituting a distributed processing system is changed, name information of the service can be sent efficiently.

According to the invention, when a name information retrieval request is received, name information of its own node and name information of other nodes designated by the system definition are retrieved successively and sent to the requester. Accordingly, a plurality of different transaction services provided by a plurality of nodes constituting a distributed processing system can be searched efficiently.

It should be further understood by those skilled in the art that although the foregoing description has been made on embodiments of the invention, the invention is not limited thereto and various changes and modifications may be made without departing from the spirit of the invention and the scope of the appended claims.

1-15. (canceled)

16. A method of providing naming service in a distributed processing system having a plurality of nodes, each of which has a system definition including information about a node to which name information or an advertisement is to be transmitted, connected to one another through a network, a first node of the plurality of nodes being arranged to provide name information to the other nodes, comprising the steps of:
receiving a name information retrieval request and the name information at one of the plurality of nodes;
sending the name information retrieval request to a second node designated by the system definition of the one of the plurality of nodes;
retrieving name information based on the name information retrieval request at the node whose system definition has been designated for acquiring name information for the node;
acquiring information on a service corresponding to the name information;
judging, at each of the plurality of nodes, whether or not an advertisement showing a name information on a state-changed service has been received;
updating, in response to positive judgment at the judging step, the name information having been stored according to the name information received; and
sending an advertisement regarding present name information to each of nodes defined in accordance with the system definition of the first node.

17. The method according to claim 16, wherein:
one of the plurality of nodes comprises a predetermined kind of device, and
the method further comprises receiving name information having been updated when the mane information retrieval request has been received from the predetermined kind of device.

18. The method according to claim 17, wherein the predetermined kind of device comprises a client server.

19. The method according to claim 16, wherein the advertisement is arranged not to be sent to a node due to exclusive information having been defined in the system definition.

20. A method of providing naming service in a distributed processing system having a plurality of nodes, each of which has a system definition including information about a node to which name information or an advertisement is to be transmitted, connected to one another through a network, a first node of the plurality of nodes being arranged to provide name information to the other nodes, comprising the steps of:
receiving a name information retrieval request and the name information at one of the plurality of nodes;
sending the name information retrieval request to a second node designated by the system definition of the one of the plurality of nodes;
retrieving name information based on the name information retrieval request at the node whose system definition has been designated for acquiring name information for the node;
acquiring information on a service corresponding to the name information;
judging, at each of the plurality of nodes, whether or not an advertisement showing a name information on a state-changed service has been received;
updating, in response to positive judgment at the judging step, the name information having been stored according to the name information received; and
sending an advertisement regarding present name information to each of nodes defined in accordance with the system definition of the first node, wherein:
one of the plurality of nodes comprises a predetermined kind of device comprising a client server, and
the method further comprises receiving name information having been updated when the mane information retrieval request has been received from the predetermined kind of device.

21. A method of providing naming service in a distributed processing system having a plurality of nodes, each of which has a system definition including information about a node to which name information or an advertisement is to be transmitted, connected to one another through a network, the plurality of nodes including a first node, a second node and a third node, the method comprising the steps of:
receiving a name information retrieval request at the first node, system definition of the first node designating the second node;
sending a name information retrieval request to the second node from the first node, system definition of the second node designating the third node;
retrieving, from the third node, name information of the third node at the second node whose system definition is designated for acquiring name information for the third node;
sending, from the second node, the name information of the third node and name information of the second node to the first node;
acquiring information about a service corresponding to the name information of the third node and the name information of the second node;
judging, at the first node, whether or not an advertisement indicating name information regarding a service of which state has changed has been received from the second node or the third node;
updating, in response to positive judgment at the judging step, name information having been stored at the first node according to the name information received regarding a service of which state has changed; and
sending an advertisement regarding updated name information to a node defined the system definition of the first node.
